(19) United States
(12) Patent Application Publication
(10) Pub. No.: US 2023/0222348 A1
(43) Pub. Date: Jul. 13, 2023

(54) PERSONAL INFORMATION DETECTION REINFORCEMENT METHOD USING MULTIPLE FILTERING AND PERSONAL INFORMATION DETECTION REINFORCEMENT APPARATUS USING THE SAME

(71) Applicant: SPICEWARE CO., LTD., Seoul (KR)

(72) Inventors: Keunjin KIM, Seoul (KR); Kyungmin KIM, Seoul (KR); Sungju PARK, Seoul (KR)

(73) Assignee: SPICEWARE CO., LTD., Seoul (KR)

(21) Appl. No.: 18/180,910

(22) Filed: Mar. 9, 2023

Related U.S. Application Data
(63) Continuation of application No. PCT/KR2021/019348, filed on Dec. 17, 2021.

(30) Foreign Application Priority Data
Dec. 6, 2021 (KR) 10-2021-0172572

(51) Int. Cl. G06N 3/088; G06N 3/09

(52) U.S. Cl. CPC G06N 3/088; G06N 3/09

(57) ABSTRACT

Disclosed are a personal information detection reinforcement method using multiple filtering and a personal information detection reinforcement apparatus using the same. The personal information detection reinforcement method includes performing first filtering of input data using record data and pattern data, classifying a class of the first-filtered input data using a previously constructed supervised learning model, performing second filtering of the first-filtered input data using an unsupervised-based algorithm based on the classified class, and updating the supervised learning model based on the second-filtered result data.

### CROSS-REFERENCE TO RELATED APPLICATIONS

The present application is a continuation of International Patent Application No. PCT/KR2021/019348, filed on Dec. 17, 2021, which is based upon and claims the benefit of priority to Korean Patent Application Nos. 10-2021-0172572 filed on Dec. 06, 2021. The disclosures of the above-listed applications are hereby incorporated by reference herein in their entirety.

### BACKGROUND

Embodiments of the inventive concept described herein relate to a personal information detection reinforcement method using multiple filtering and a personal information detection reinforcement apparatus using the same.

Supervised learning is one method of machine learning for constructing one learning model by using data with correct answers as training data. When input data is input, the constructed learning model may analyze a characteristic of the input data and may output a class of the input data as result data.

However, because the supervised learning performs statistics-based prediction, wrong prediction may be performed even for input data capable of being clearly distinguished.

### SUMMARY

The inventive concept provides a personal information detection reinforcement method using multiple filtering and a personal information detection reinforcement apparatus using the same.

The technical objects of the inventive concept are not limited to the above-mentioned ones, and the other unmentioned technical objects will become apparent to those skilled in the art from the following description.

In accordance with an aspect of the inventive concept, there is provided a personal information detection reinforcement method using multiple filtering including performing first filtering of input data using record data and pattern data, classifying a class of the first-filtered input data using a previously constructed supervised learning model, performing second filtering of the first-filtered input data using an unsupervised-based algorithm based on the classified class, and updating the supervised learning model based on the second-filtered result data.

In accordance with another aspect of the inventive concept, there is provided a personal information detection reinforcement apparatus using multiple filtering including a communication unit, a memory storing at least one process for reinforcing personal information detection using the multiple filtering, and a processor that operates depending on the at least one process. Based on the at least one process, the processor may perform first filtering of input data using record data and pattern data, may classify a class of the first-filtered input data using a previously constructed supervised learning model, may perform second filtering of the first-filtered input data using an unsupervised-based algorithm based on the classified class, and may update the supervised learning model based on the second-filtered result data.

The other detailed items of the inventive concept are described and illustrated in the specification and the drawings.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIG. 1 is a drawing for describing a personal information detection reinforcement apparatus according to an embodiment of the inventive concept;

FIG. 2 is a flowchart of a personal information detection reinforcement method according to an embodiment of the inventive concept; and

FIG. 3 is a drawing for describing the entire process of updating a supervised learning model based on personal information detection and the detected result according to an embodiment of the inventive concept.

### DETAILED DESCRIPTION

The above and other aspects, features and advantages of the invention will become apparent from the following description of the following embodiments given in conjunction with the accompanying drawings. However, the inventive concept is not limited to the embodiments disclosed below, but may be implemented in various forms. The embodiments of the inventive concept are provided to make the disclosure of the inventive concept complete and fully inform those skilled in the art to which the inventive concept pertains of the scope of the inventive concept.

The terms used herein are provided to describe the embodiments but not to limit the inventive concept. In the specification, the singular forms include plural forms unless particularly mentioned. The terms “comprises” and/or “comprising” used herein does not exclude presence or addition of one or more other elements, in addition to the aforementioned elements. Throughout the specification, the same reference numerals dente the same elements, and “and/or” includes the respective elements and all combinations of the elements. Although “first”, “second” and the like are used to describe various elements, the elements are not limited by the terms. The terms are used simply to distinguish one element from other elements. Accordingly, it is apparent that a first element mentioned in the following may be a second element without departing from the spirit of the inventive concept.

Unless otherwise defined, all terms (including technical and scientific terms) used herein have the same meaning as commonly understood by those skilled in the art to which the inventive concept pertains. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein.

Hereinafter, exemplary embodiments of the inventive concept will be described in detail with reference to the accompanying drawings.

The “apparatus” in the specification may include all of various devices capable of performing arithmetic processing and providing a user with the result of performing the arithmetic processing. For example, the apparatus may be in the form of a computer and a mobile terminal. The computer may be in the form of a server which receives a request from a client and performs information processing. Furthermore, a sequencing device which performs sequencing may correspond to the computer. The mobile terminal may include a mobile phone, a smartphone, personal digital assistants (PDA), a portable multimedia player (PMP), navigation, a laptop personal computer (PC), a slate PC, a tablet PC, an ultrabook, a wearable device (e.g., a smartwatch, a smart glass, or a head mounted display (HMD) or the like.

The “supervised learning model” in the specification may be a learning model based on artificial intelligence, which may be learned based on various artificial intelligence algorithms. All of algorithms for learning, for example, a convolutional neural network (CNN), a deep neural network (DNN), a recurrent neural network (RNN), k-nearest neighbors (KNN), and a support vector machine (SVM) are applicable.

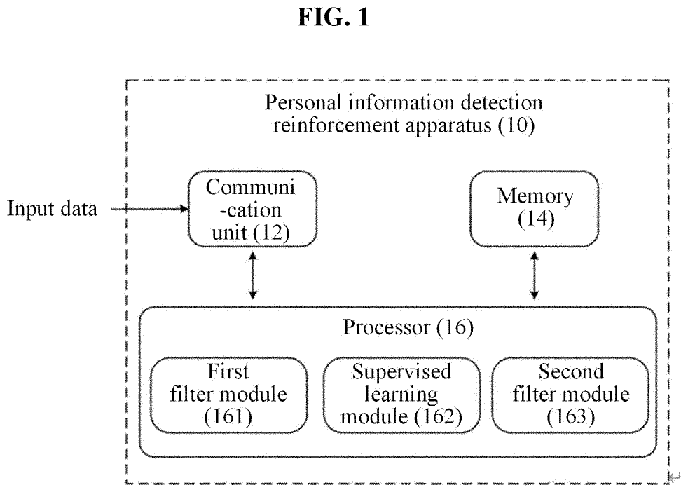

FIG. 1 is a drawing for describing a personal information detection reinforcement apparatus according to an embodiment of the inventive concept.

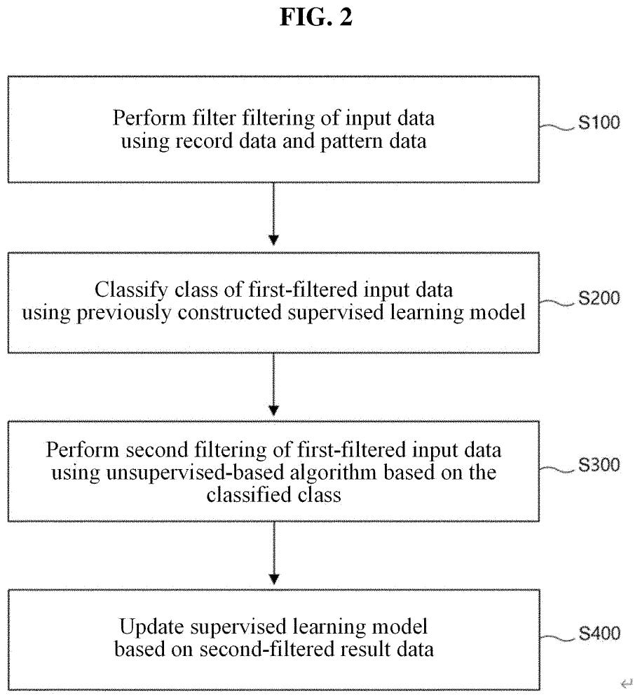

FIG. 2 is a flowchart of a personal information detection reinforcement method according to an embodiment of the inventive concept.

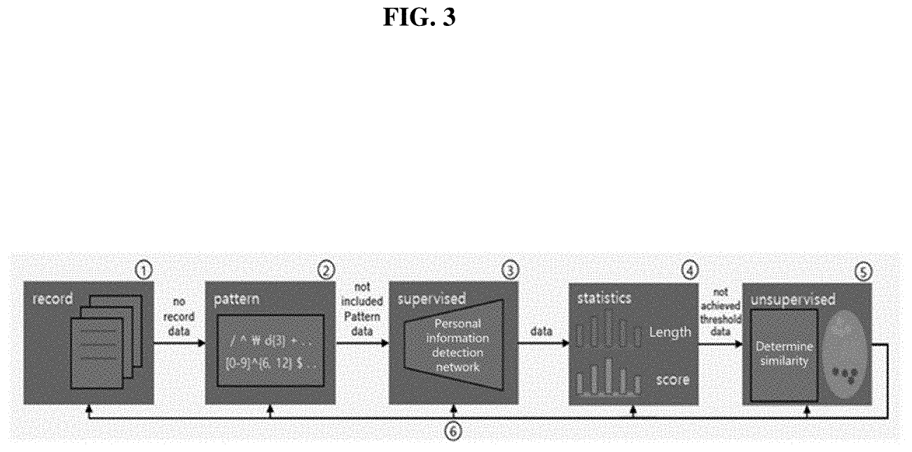

FIG. 3 is a drawing for describing the entire process of updating a supervised learning model based on personal information detection and the detected result according to an embodiment of the inventive concept.

Referring to FIG. 1, a personal information detection reinforcement apparatus (hereinafter referred to as an “apparatus”) 10 according to an embodiment of the inventive concept may include a communication unit 12, a memory 14, and a processor 16. However, the apparatus 10 may include less or more components than the components shown in FIG. 1.

The communication device 12 may receive input data from an external device. Herein, the external device may be a mobile terminal used by an individual and may be a server device managed by a provider (or a company), but not limited thereto.

Herein, the input data may be data which is applied to a supervised learning model and is used to predict what personal information is included. The personal information may include a name, a resident registration number, an address, a phone number, or the like.

The communication device 12 of the apparatus 10 according to an embodiment of the inventive concept may receive the input data from the external device over a communication network.

Herein, the communication network may include various types of communication networks and may use, for example, a wireless communication scheme, such as wireless local area network (WLAN), wireless-fidelity (Wi-Fi), wireless broadcast (Wibro), worldwide interoperability for microware access (WiMAX), or high speed downlink packet access (HSDPA), or a wired communication scheme, such as an Ethernet, xDSL (ADSL, VDSL), hybrid fiber coax (HFC), fiber to the curb (FTTC), or fiber to the home (FTTH).

Meanwhile, the communication network is not limited to the above-mentioned communication schemes, which may include all types of communication schemes which are well known or will be developed in the future other than the above-mentioned communication schemes.

The memory 14 may store at least one process for reinforcing personal information detection using multiple filtering. Furthermore, the memory 14 may store a previously constructed supervised learning model. Herein, the supervised learning model may predict a class for personal information included in the input data. Because the supervised learning model is able to provide a wrong prediction result because of performing probability-based prediction, an embodiment of the inventive concept may supplement the wrong prediction of the supervised learning model using multiple filters.

The processor 16 may perform the overall function for controlling the apparatus 10, various operations associated with prediction of the supervised learning model, and various operations associated with the supplement of the wrong prediction of the supervised learning model. For example, the processor 16 may execute the program or processes stored in the memory 14 to perform the overall function for controlling the apparatus 10, the various operations associated with the prediction of the supervised learning model, and the various operations associated with the supplement of the wrong prediction of the supervised learning model. The processor 16 may be implemented as, but not limited to, a central processing unit (CPU), a graphic processing unit (GPU), a digital signal processor (DSP), a neural processing unit (NPU), an application processor (AP), or the like.

Referring to FIG. 1, the processor 16 may include a first filter module 161, a supervised learning module 162, and a second filter module 163. However, the processor 16 may include less or more components than the components shown in FIG. 1.

Before applying the input data to the supervised learning model, the first filter module 161 may apply a record- and pattern-based preprocessing filter not to apply the input data to the supervised learning model when the input data is previously predicted data and may use the previously predicted result as the result of predicting the input data.

The supervised learning module 162 may apply the first-filtered input data (i.e., data which has never been predicted before) to the supervised learning model to perform prediction.

The supervised learning module 162 may be configured with one or more cores, which may include a processor, such as a central processing unit (CPU), a general purpose graphics processing unit (GPGPU), or a tensor processing unit (TPU) of a computing device, for data analysis and deep learning. The supervised learning module 162 may read out a computer program stored in the memory to reinforce personal information detection using multiple filtering according to an embodiment of the inventive concept. According to an embodiment of the inventive concept, the supervised learning module 162 may perform calculation for learning a neural network. The supervised learning module 162 may perform the calculation for learning the neural network, for example, processing of input data for learning in deep learning (DL), feature extraction from the input data, error calculation, and a weight update of the neural network using backpropagation. At least one of the CPU, the GPGPU, and the TPU of the supervised learning module 162 may process learning of a network function. For example, the CPU and the GPGPU may process learning of the network function and data classification using the network function together. Furthermore, in an embodiment of the inventive concept, learning of the network function and data classification using the network function may be processed by using processors of a plurality of computing devices. Furthermore, the computer program performed in the computing device according to an embodiment of the inventive concept may be a program executable by the CPU, the GPGPU, or the TPU.

The second filter module 163 may apply a post-processing filter using an unsupervised-based algorithm to determine whether the predicted result of the supervised learning model is correct and calibrate an incorrect predicted result.

The calibrated predicted result may be learned by the supervised learning model and the accuracy of predicting the supervised learning model may be improved.

Hereinafter, a description will be given in detail of a method for supplementing a supervised learning technique through preprocessing filtering (first filtering) and post-processing filtering (second filtering) in the processor 16 according to an embodiment of the inventive concept with reference to FIGS. 2 and 3. Herein, an operation of the processor 16 may be performed by the apparatus 10.

Referring to FIG. 2, in operation S100, the processor 16 may perform first filtering of input data using record data and pattern data.

In operation S200, the processor 16 may classify a class of the first-filtered input data using a previously constructed supervised learning model.

In operation S300, the processor 16 may perform second filtering of the first-filtered input data using an unsupervised-based algorithm based on the classified class.

In operation S400, the processor 16 may update the supervised learning model based on the second-filtered result data.

As described above, the input data may be data including personal information. An embodiment of the inventive concept may detect whether personal information included in the input data is any type of personal information by means of the supervised learning model. At this time, an embodiment of the inventive concept may perform the first filtering and the second filtering in preparation for the case where prediction of the supervised learning model is incorrect, thus accurately identifying a type of the personal information included in the input data. An embodiment of the inventive concept may learn the result data correctly predicted by means of the first filtering and the second filtering, thus improving performance of the supervised learning model.

In operation S100, the processor 16 may compare the input data with the record data and the pattern data to perform the first filtering.

Herein, the record data may be data previously collected based on a previously predicted result of the supervised learning model. In detail, only data in which the predicted result is correct among pieces of input data, the prediction of which is performed after being previously input to the supervised learning model, may be collected as the record data. The record data may be collected as the input data and the class (predicted result) of the input data may be mapped with each other. The pattern data may be previously stored data about a data type based on a regular expression. Because pieces of personal information have different forms, a form of each of the pieces of personal information may be preset as pattern data.

In detail, the processor 16 may identify there is the same data as the input data among the pieces of previously collected record data. When there is the same data, the processor 16 may determine a class of the data as a class of the input data. For example, when the input data is “Hong Gildong” and when there is data, “Hong Gildong”, among the pieces of record data and the class mapped with the data is “name”, a class of the input data, “Hong Gildong”, may be determined as “name”.

On the other hand, as shown in FIG. 3, when there is no the same data as the input data among the pieces of previously collected record data, the processor 16 may compare the input data with pattern data.

In detail, the processor 16 may perform regular expression pattern inspection of data which does not correspond to the record data and may determine whether there is pattern data corresponding to a type of the input data among the pieces of previously stored pattern data. When there is the pattern data corresponding to the type of the input data, the processor 16 may determine a class of the data as a class of the input data. For example, when input data is a “000000-0000000 (a form of the resident registration number)” and when there is a pattern of “\d{6}\-[1-4]\d{6}” among the pieces of pattern data by means of the regular expression pattern inspection, a class of the input data, “000000-0000000”, may be determined as the “resident registration number”.

On the other hand, as shown in FIG. 3, when there is no the same pattern data as the type of the input data among the pieces of previously stored pattern data, the processor 16 may input the input data to the supervised learning model.

In operation S200, the processor 16 may apply input data in which pattern data is not present to the supervised learning model, thus classifying a class of the input data in which the pattern data is not present.

In other words, the data in which the class classification is performed in operation S200 may refer to the first-filtered data in operation S100. In detail, the first-filtered data may refer to data which is not included in the record data and the pattern data. In operation S200, the processor 16 may classify a class of the data which is not included in the record data and the pattern data.

When a feature value of the first-filtered input data deviates from a predetermined range with respect to a data statistics value for the classified class, in operation S300, the processor 16 may determine that the classified class is not correct.

Herein, the predetermined range may be set based on a data characteristic. Herein, the data characteristic may include, but is not limited to, a length distribution of data, a character number distribution of the data, and a learning score distribution. All of various characteristics suitable for data are applicable.

According an embodiment, the predetermined range may be set based on at least one of the length distribution of the data, the character number distribution of the data, and the learning score distribution. The entire length, the number of Hangul, English, numbers, and special characters, which are included in personal information, a correct and incorrect score of the learned result are different per personal information, and a statistical value may be different per personal information. The processor 16 may set a range with respect to the statistical value per personal information and may determine whether the classified class is correct depending on whether the feature value of the input data is included in the range.

For example, when the classified class is “name” and when pieces of name data are distributed at 0.5 among values between 0 and 1 in the character number distribution or the character number distribution and the learning score distribution and the predetermine range ±0.1, it may be determined that the classified class is correct when the feature value of the input data should be a value between 0.4 and 0.6.

When the feature value is not included in the predetermined range in the character number distribution or at least one of the character number distribution and the learning score distribution, it may be determined that the class classified for the input data is not correct.

When it is determined that the classified class is not correct, the processor 16 may apply the unsupervised-based algorithm to the input data.

In detail, the processor 16 may measure a similarity between the first-filtered input data and data of each of the plurality of classes learned by the supervised learning model and may select a class with the largest similarity value among the plurality of classes as a class of the first-filtered input data to calibrate the classified class.

For example, when the class of the input data is classified as “name” by the supervised learning model and when a similarity between the input data and data of “mobile phone number” is highest when measuring similarities between the input data and pieces of data of the plurality of classes (e.g., “address”, “resident registration number”, “mobile phone number”, and the like), the processor 16 may calibrate the class classified as “name” for the input data as “mobile phone number”.

In operation S400, the processor 16 may add the calibrated class and the input data as training data of the supervised learning model to update the supervised learning model.

In other words, the processor 16 may perform learning by using the input data as an input value and a correct answer value as a class calibrated by the unsupervised-based algorithm, rather than a wrong predicted result of the supervised learning model, thus updating the supervised learning model.

Furthermore, the input data and the class calibrated for the input data may be added to the record data, the pattern data, and data associated with the unsupervised-based algorithm. Thus, thereafter, the accuracy of preprocessing filtering using the record data and the pattern data and post-processing filtering using the unsupervised-based algorithm may be improved.

According an embodiment, when the update (operation S400) of the supervised learning model is achieved after the one entire process (operations S100 to S300) is ended, the inventive concept may further include updating a previously constructed record-based model, a previously constructed pattern-based model, a previously constructed statistics-based model, and a previously constructed unsupervised learning model based on the second-filtered result data.

In other words, the update may be performed using the same data for the remaining four models as well as the supervised learning model.

When the result value of the process (operations S100 to S300) is information which is not previously added, the record-based model may be updated by adding the result value to a record list.

When the result value of the process (operations S100 to S300) is a pattern which is not previously added, the pattern-based model may be updated by adding the result value to a pattern list.

As described above, the supervised learning model may be updated by learning the result of the process (operations S100 to S300) as a correct answer value.

The statistics-based model may be updated by extracting and storing a feature value required in statistics from the result value of the process (operations S100 to S300).

The unsupervised learning model may be updated by performing learning by using the result itself of the process (operations S100 to S300) as an input value.

FIG. 2 illustrates that operations S100 to S300 are sequentially executed, but this only illustratively describes the technical scope of the embodiment. Because a person having ordinary skill in the art to which the embodiment pertains changes and executes the order described in FIG. 2 in the range which does not depart from the essential characteristic of the embodiment or executes operations S100 to S300 in parallel to apply various corrections and modifications, FIG. 2 is not limited to the time series order.

Meanwhile, in the above-mentioned description, operations S100 to S300 may be further divided into additional operations or may be combined into fewer operations, according to an implementation example of the inventive concept. Furthermore, some operations may be omitted if necessary, and an order between operations may be changed.

The above-mentioned personal information detection reinforcement method for the multiple filtering according to an embodiment of the inventive concept may be implemented as a program (or application) to be combined with a computer which is hardware to be executed and may be stored in a computer-readable storage medium.

In some embodiments, the above-discussed method of FIG. 2, according to this disclosure, is implemented in the form of program being readable through a variety of computer means and be recorded in any non-transitory computer-readable medium. Here, this medium, in some embodiments, contains, alone or in combination, program instructions, data files, data structures, and the like. These program instructions recorded in the medium are, in some embodiments, specially designed and constructed for this disclosure or known to persons in the field of computer software. For example, the medium includes hardware devices specially configured to store and execute program instructions, including magnetic media such as a hard disk, a floppy disk and a magnetic tape, optical media such as CD-ROM (Compact Disk Read Only Memory) and DVD (Digital Video Disk), magneto-optical media such as floptical disk, ROM, RAM (Random Access Memory), and flash memory. Program instructions include, in some embodiments, machine language codes made by a compiler compiler and high-level language codes executable in a computer using an interpreter or the like. These hardware devices are, in some embodiments, configured to operating as one or more of software to perform the operation of this disclosure, and vice versa.

A computer program (also known as a program, software, software application, script, or code) for the above-discussed method of FIG. 2 according to this disclosure is, in some embodiments, written in a programming language, including compiled or interpreted languages, or declarative or procedural languages. A computer program includes, in some embodiments, a unit suitable for use in a computing environment, including as a stand-alone program, a module, a component, or a subroutine. A computer program is or is not, in some embodiments, correspond to a file in a file system. A program is, in some embodiments, stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program is, in some embodiments, deployed to be executed on one or more computer processors located locally at one site or distributed across multiple remote sites and interconnected by a communication network.

According to the disclosed embodiment, the personal information detection reinforcement apparatus may add multiple filters to supplement wrong prediction of supervised learning.

In detail, the personal information detection reinforcement apparatus may fail to output a wrong result for a value previously selected by a user and data having a clear pattern by means of a record-based search filter.

Furthermore, the personal information detection reinforcement apparatus may calibrate data classified as an uncertain class by means of supervised learning as a class with higher accuracy by means of a filter based on the unsupervised-based algorithm.

Although the exemplary embodiments of the inventive concept have been described with reference to the accompanying drawings, it will be understood by those skilled in the art to which the inventive concept pertains that the inventive concept can be carried out in other detailed forms without changing the technical spirits and essential features thereof. Therefore, the above-described embodiments are exemplary in all aspects, and should be construed not to be restrictive.

What is claimed is:

1. A personal information detection reinforcement method using multiple filtering, the personal information detection reinforcement method being performed by an apparatus and comprising:
performing first filtering of input data using record data and pattern data;
classifying a class of the first-filtered input data using a previously constructed supervised learning model;
performing second filtering of the first-filtered input data using an unsupervised-based algorithm based on the classified class; and
updating the supervised learning model based on the second-filtered result data.

2. The personal information detection reinforcement method of claim 1, wherein the performing of the first filtering comprises:
comparing the input data with the record data being previously collected based on a predicted result of the supervised learning model to determine whether the input data corresponds to the record data; and
performing regular expression pattern inspection of data which does not correspond to the record data and determining whether there is pattern data corresponding to a type of the input data among pieces of pattern data previously stored about a data type.

3. The personal information detection reinforcement method of claim 2, further comprising:
determining a class corresponding to the pattern data as a class of input data in which the pattern data is present, with respect to the input data in which the pattern data is present.

4. The personal information detection reinforcement method of claim 2, wherein the classifying of the class comprises:
applying input data in which the pattern data is not present to the supervised learning model to classify a class of the input data in which the pattern data is not present.

5. The personal information detection reinforcement method of claim 1, wherein the performing of the second filtering comprises:
performing an unsupervised-based algorithm for the first-filtered input data, based on the classified class, and determining whether the classified class is correct for the first-filtered input data.

6. The personal information detection reinforcement method of claim 5, wherein the determining of whether the class is correct comprises:
determining that the classified class is not correct, when a feature value of the first-filtered input data deviates from a predetermined range with respect to a data statistics value for the classified class; and
measuring a similarity between the first-filtered input data and data of each of a plurality of classes learned by the supervised learning model and selecting a class with the largest similarity value among the plurality of classes as a class of the first-filtered input data to calibrate the classified class.

7. The personal information detection reinforcement method of claim 6, wherein the predetermined range is set based on a data characteristic, and
wherein the data characteristic includes a length distribution of data, a character number distribution of the data, and a learning score distribution.

8. The personal information detection reinforcement method of claim 6, wherein the updating of the supervised learning model comprises:
adding the calibrated class and the input data as training data of the supervised learning model to update the supervised learning model.

9. The personal information detection reinforcement method of claim 1, further comprising:
updating a previously constructed record-based model, a previously constructed pattern-based model, a previously constructed statistics-based model, and a previously constructed unsupervised learning model based on the second-filtered result data.

10. A personal information detection reinforcement apparatus using multiple filtering, the personal information detection reinforcement apparatus comprising:
a communication unit;
a memory storing at least one process for reinforcing personal information detection using the multiple filtering; and
a processor configured to operate depending on the at least one process,
wherein, based on the at least one process, the processor performs first filtering of input data using record data and pattern data, classifies a class of the first-filtered input data using a previously constructed supervised learning model, performs second filtering of the first-filtered input data using an unsupervised-based algorithm based on the classified class, and updates the supervised learning model based on the second-filtered result data.
